(19) United States
(12) Patent Application Publication
(10) Pub. No.: US 2012/0191377 A1
(43) Pub. Date: Jul. 26, 2012

(54) METHOD AND DEVICE FOR ULTRASONIC TESTING

(75) Inventors: GÜNTER ENGL, ERLANGEN (DE); FRIEDRICH MOHR, NUERNBERG (DE); MICHAEL KRÖENING, SAARBRUECKEN (DE); KRISHNA MOHAN REDDY, CHENNAI (IN)

(73) Assignee: INTELLIGENDT SYSTEMS & SERVICES GMBH, ERLANGEN (DE)

(21) Appl. No.: 13/437,320

(22) Filed: Apr. 2, 2012

Related U.S. Application Data
(63) Continuation of application No. PCT/EP2010/064621, filed on Oct. 1, 2010.

(30) Foreign Application Priority Data
Oct. 1, 2009 (DE) 10 2009 045 249.4
Nov. 30, 2009 (DE) 10 2009 047 317.3

(51) Int. Cl. G06F 19/00; G01N 29/04

(52) U.S. Cl. 702/39; 73/628

(57) ABSTRACT

A method performs ultrasound testing of a test body having a hole extending in an axial direction. The method include disposing a test head within the hole. The test head extends in the axial direction and has sensor rings which are at a distance from one another and are disposed one behind the other in the axial direction. The sensor rings have a plurality of ultrasound transducers which are at a distance from one another. The ultrasound transducers disposed in a segment of each of the sensor rings extend in a circumferential direction of a respective sensor ring on at least a subsection of a circumference of the respective sensor ring. An ultrasound test pulse is injected into the test body. Measured values of first and second echo signals are evaluated to determine at least one of a location or an orientation of a fault in the test body.

### CROSS-REFERENCE TO RELATED APPLICATION

This is a continuation application, under 35 U.S.C. §120, of copending international application No. PCT/EP2010/064621, filed Oct. 1, 2010, which designated the United States; this application also claims the priority, under 35 U.S.C. §119, of German patent applications DE 10 2009 045 249.4, filed Oct. 1, 2009 and DE 10 2009 047 317.3, filed Nov. 30, 2009; the prior applications are herewith incorporated by reference in their entirety.

### BACKGROUND OF THE INVENTION

1. Field of the Invention

Ultrasound can be used to verify faults and defects in the volume and on the surfaces of parts and technical components. One advantage of the pulse-echo technique, which is preferably used for ultrasound testing, is the excellent capability to verify area discontinuities, such as cracks. One precondition for reliable verification is that the faults which are present in the test body are suitably ensonified. Ultrasound tests are used both in manufacturing, as an integrated test for the purpose of quality assurance, and as a scheduled test during the course of servicing and maintenance, in order to ensure that the test object is still suitable for use.

In principle, when using the pulse-echo method for ultrasound testing, the only faults which are verified are those whose ultrasound echo is received. The question as to whether an ultrasound echo such as this reflected from a fault is or is not detected by the test device that is used is therefore dependent to a major extent on the geometric arrangement between the sensor, the receiver and the fault which is present in the test body, as well as the reflection characteristics of this fault.

In order to obtain an image of the damage to the workpiece or test body to be tested, which image is as complete as possible, the sound field which is used for testing is injected into the volume to be tested at a multiplicity of different points, from a multiplicity of different sound incidence directions.

This allows the volume areas and surfaces to be tested to be largely covered. Normally, the surface of the test object is scanned with a test head for this purpose, thus making it possible to move to a multiplicity of different injection points. In order furthermore to cover as many different sound incidence directions as possible, a test head such as this generally has a plurality of ultrasound transducers which are oriented in different directions. The ultrasound field used for testing is therefore normally injected into the test body at right angles, as well as at an angle of 45°, to the surface of the test body.

The described scanning method leads to relatively long test times, however. If the intention is to carry out the test in an automated form, then complex manipulators are required in order to produce such a scanning movement. Finally, as before, a certain amount of uncertainty remains in the test assessment since it is neither possible to cover or move to all the feasible injection points nor to move to or cover all the feasible sound incidence directions, in such a way that the type of fault and the fault geometry can always be reliably derived. This uncertainty in the assessment of the test results can lead to unnecessary scrap in manufacture, or to an adverse effect on technical safety.

In principle, the nature and number of the ultrasound sensors used in a test system are optimized for the stated test purpose. In this case, both the accessibility to the test surface and the validity of the test with respect to a potential fault configuration must be taken into account.

The so-called transducer array technique represents one known technical further development in ultrasound technology. When using this technique, a transducer array test head carries out the function of a plurality of ultrasound sensors. A transducer array test head can be used to electronically control both the sound incidence angle and the focusing of the sound field. The transducer array technique places relatively stringent demands on the test electronics, however, with long test times as before. The test times remain high since only the number of individual sensors required can be reduced by the use of the transducer array, when using the transducer array technique; however, in principle, the number of test cycles remains unchanged.

The aim of modern ultrasound tests is often to also make a quantitative statement relating to the image of the damage to the test body, in addition to a qualitative statement. Therefore, in addition to the position of the fault, the nature of the fault and its extent are also of interest. The suitability of the test object for further use can be assessed with greater confidence on the basis of the result of a quantitative test. Depending on the seriousness of the fault found, this leads to consideration, as a measure, of removal from further use, repair to the test object or release for further operation.

Furthermore, 3D visualization of the test images is desirable for the purposes of quantitative non-destructive testing. Test results are already visualized in this form with the aid of the transducer array technique, with the test images that are produced generally being visualized as B and C images in cross section and/or in plan view, using known tomographic techniques. However, actual 3D imaging is not yet possible at the moment. Instead of this, 2D images are simply converted to 3D images, in which case the limited number of sound incidence directions means that it is necessary to accept the disadvantage that the system is not sensitive to area discontinuities with undefined orientations obliquely with respect to the measurement plane.

One important subarea of ultrasound testing is borehole testing (boresonic inspection). This is used, inter alia, for drilled-out hollow turbine shafts or axles of railroad wheelsets. Ultrasound systems for borehole testing are commercially available.

In the case of these known ultrasound systems, a rotating test lance is inserted into a cavity in a test body, normally a borehole which is located centrally in the test body. As an alternative to rotation of the test lance, the workpiece that is intended to be examined can be rotated about this test lance. Ultrasound systems such as these operate using the principle of ultrasound multichannel technology. A plurality of ultrasound sensors in the test head system inject the ultrasound fields used for testing at different sound incidence angles from the inside of the workpiece, that is to say from the direction of the borehole, into the material of the unit under test. In general, in addition to sensors whose ultrasound field is oriented at right angles to the longitudinal axis of the test body, discrete sensors are also used, whose ultrasound field is inclined to 45° with respect to the longitudinal axis. The so-called angled mirror effect can be used with the aid of the latter sensors to verify in particular external cracks which run in the circumferential direction of the test body. A method which allows external cracks running in the longitudinal direction of the workpiece to be verified is disclosed, for example, in published, non-prosecuted German patent application DE 199 52 407 A1.

The detected faults are associated three-dimensionally, and their size and extent are assessed, on the basis of reference reflectors, whose orientation in the workpiece is known. By way of example, grooves which are present on the outside of a test body of the same type as the test object, or circular disk reflectors embedded in its volume, which are oriented ideally with respect to the respective sound incidence direction, are used as reference or substitute reflectors. One disadvantage of these known test methods is the relatively long test time, since the borehole surface is scanned, for example, helically. Furthermore, the use of substitute reflectors for verification of findings means that real faults with different reflection characteristics are detected only weakly, or not at all. A quantitative assessment of the nature and the extent of the findings is likewise possible only to a very limited extent.

### SUMMARY OF THE INVENTION

The object of the invention is to specify a method and an apparatus for ultrasound testing which are improved with respect to the required test times and with respect to fault verification and fault assessment, in comparison to the methods and apparatuses known from the prior art.

In the method according to the invention for ultrasound testing, in a first step, a test head is arranged within a hole which is present in a test body and extends in an axial direction. The test head extends in the axial direction and has a plurality of sensor rings which are at a distance from one another and are arranged one behind the other in this axial direction. These sensor rings each extend on a plane at right angles to the axial direction and each have a plurality of ultrasound transducers which are at a distance from one another. The ultrasound transducers are arranged in a segment of a respective sensor ring which extends in the circumferential direction of the respective sensor ring on at least a subsection of a circumference of the respective sensor ring. The ultrasound transducers in different sensor rings may in this case—considered in the axial direction—be arranged both one behind the other and slightly offset with respect to one another. In a further method step, an ultrasound test pulse which originates from a segment of a sensor ring is injected into the test body. In this case, the ultrasound transducers are excited synchronously or sequentially to emit individual pulses of the same type. In this case, synchronously means that a plurality of ultrasound transducers which are located in a segment of a sensor ring, and in particular all of them, are excited at the same time. The superposition of these individual pulses results in the ultrasound test pulse. In a further method step, a first echo signal is received by a first ultrasound transducer and a second echo signal is received by a second ultrasound transducer in the test head. This applies to any given first and second ultrasound transducers in the entire test head. Both the first and the second echo signals are produced by reflection of the injected ultrasound test pulse at one and the same fault which is present in the test body. The first and the second ultrasound transducers are arranged spatially separated from one another. The ultrasound transducers which are used here are preferably configured such that they have a sound field beam angle of up to 120° in the axial direction, which is therefore considerably greater than the sound field beam angle of up to about 20° provided by ultrasound transducers used in conventional ultrasound methods. A refinement of the ultrasound transducers such as this means that the ultrasound pulse produced by one ultrasound transducer ensonifies a larger area, with a fault which is present in a workpiece being detected over a larger aspect angle range. In addition, the further sound field beam angle makes it possible to produce longitudinal/and transversal waves at the same time.

In a further method step, the measured values of the first and second echo signals are evaluated in order to determine the location and/or the orientation of the fault in the test body relative to the first and second ultrasound transducers. The location/orientation determination becomes more precise the greater the number of first and second ultrasound transducers which are used in a test head.

In the present context, a test head does not mean a conventional test head with just one ultrasound transducer which emits in a fixed emission direction. In fact, a test head is considered to be a test head system which contains a multiplicity of ultrasound transducers. In order to make reading easier, the term test head is nevertheless retained.

The method according to the invention for ultrasound testing is based on the below described knowledge.

Since the superposition of ultrasound fields in a workpiece is in principle a linear problem, it is irrelevant whether the ultrasound test pulse under discussion is injected into the test body by synchronous or sequential operation of the ultrasound transducers. If the ultrasound transducers are operated sequentially, then the received signals are superposed retrospectively—purely by computation.

This is also the case when the ultrasound transducers which are arranged in a segment of a respective sensor ring are used to inject the ultrasound test pulse into the test body. The ultrasound test pulse which is injected into the unit under test with a beam angle defined by the size of this segment can have a further test pulse superposed on it—purely by computation—which is emitted from the corresponding segment after rotation of the test head.

According to a first embodiment, the test head is therefore rotated about the axial direction L between the injection of two successive ultrasound test pulses. According to one development, a multiplicity of test pulses are injected into the test body in order to scan it, and the test head is moved along a test path, which is oriented in the axial direction. Preferably, the test head is rotated and/or moved such that a first sound field of a first test pulse and a second sound field of a second test pulse partially overlap one another.

Since the superposition of ultrasound fields is in principle a linear problem, the ultrasound fields which are used for testing can be superposed retrospectively by computation. It is particularly advantageous if the individual test pulses which are emitted during rotation of the test head about the axial direction are superposed—purely computationally—such that the ultrasound field provided for testing results in a ring wave.

An ultrasound test is preferably carried out in such a way that, first of all, the ultrasound test head is moved along the axial direction of the hole, scanning only a segment of the test body. By way of example, only a quarter segment of the test body is scanned in the axial direction. The test head is then rotated through an appropriate angle, and the test body is scanned once again, on this occasion in an adjacent segment. After an appropriate number of scan runs, the results are superposed by superposition of the respective ultrasound test pulses which can be associated with one another to form a ring wave, and the echo signals are evaluated.

According to one alternative method variant, after emission of a test pulse, the ultrasound test head is rotated through an appropriate angle, for example 45°, with a further test pulse then being emitted. After one complete revolution, a ring wave can be reconstructed, once again purely computationally, from the emitted ultrasound test pulses.

According to a further embodiment, the test head is rotated such that a rotation angle measured on a plane at right angles to the axial direction, between a first position in which a first ultrasound test pulse is emitted and a second position in which a second ultrasound test pulse is emitted, is less than a beam angle, likewise measured on a plane at right angles to the axial direction, of the sound field of the first or second ultrasound test pulse. In other words, the rotation angle passed through between emission of the first and the second ultrasound test pulses is actually chosen such that the ultrasound test pulses emitted at the corresponding positions overlap one another. This overlap makes it possible to ensure the computational superposition of the ultrasound test pulses.

As an alternative to the sensor rings being equipped with ultrasound transducers on a segment basis, according to a further embodiment, the test head can be configured such that the ultrasound transducers in at least one sensor ring are arranged along the complete circumference on the respective sensor ring. Particularly preferably, the ultrasound transducers are distributed uniformly along the circumference of the relevant sensor ring. The ultrasound transducers in the test head are now preferably operated synchronously or sequentially such that the ultrasound test pulse assumes the form of a ring wave which propagates at right angles to the axial direction. In the case of sequential operation, the ring wave is once again produced by computational superposition of the individual pulses.

The term ring wave, which has already been used a number of times, means an ultrasound wave which originates from the surface of the hole and propagates into the test body at right angles to the axial direction. The ring wave is divergent in the axial direction. When considering the limit case of a hole with an indefinitely small diameter, the sound source of a ring wave such as this collapses to form a source which extends along the axial direction and has a linear aperture which corresponds to the aperture of the sensor element in the axial direction. Waves which are physically not ideal are also intended to be referred to as ring waves. A ring wave such as this which is not ideal is created, for example, when a number of ultrasound transducers whose aperture and separation are greater in the circumferential direction than indicated by the sampling theorem are used to produce the ring wave.

The ring wave which is provided can advantageously be used to pass sound uniformly through the volume of the test body. The probability of detecting a fault which is present in the volume or on the surface of the test body can in this way be increased. Since a plurality of ultrasound receivers are, furthermore, provided for reception of the echo signals which originate from the faults, the orientation and size of the reflectors in the volume of the test body can be reconstructed three-dimensionally using the known rules of ultrasound tomography. This three-dimensional reconstruction may also be a phase-sensitive process, which produces particularly precise images with respect to the structure and geometry of the faults which are present.

According to one developing embodiment, the ultrasound transducers in an individual sensor ring are operated in order to emit the ring wave, while the ultrasound transducers in a plurality of sensor rings are provided for reception of the echo signal. Since a multiplicity of ultrasound transducers are now available for reception of the echo signals, this increases the probability of at least one of the ultrasound transducers also actually receiving the associated echo signal for a specific transmission position.

According to one development, a plurality of ultrasound test pulses are used for ultrasound testing of the test body, with the test head being moved along the axial direction in the time between the emission of two ultrasound test pulses. In this case, the test head is preferably moved through a step width which corresponds to half the wavelength of the ultrasound test pulse used for testing—measured in the material of the test body. Movement of the test head through half a wavelength makes it possible to computationally enlarge the effective aperture of the ultrasound transducers.

According to a further method variant, the sensor rings which are provided for emission of the ring wave are operated successively in the axial direction. In this case, only one of the sensor rings is in each case intended for emission of the ring wave, while the ultrasound transducers in all the sensor rings, that is to say if appropriate also that sensor ring which is intended for emission of the ring wave, are intended for reception of the echo signals. In other words, the sensor rings in the test head are activated successively in the same way as a moving light. The reflections are always received with the aid of all the sensor rings, with the synchronous reception by all the ultrasound transducers in all the sensor rings resulting in particular advantages with respect to the test speed.

The described method variant is particularly advantageous when the distance between the sensor rings—measured in the axial direction—also corresponds to twice the wavelength. Once one or more of the sensor rings, and in the extreme all the sensor rings in the test head, have been excited once for emission, the test head is moved through half a wavelength in the axial direction. Once the test head has been moved through a number of steps corresponding to the distance between the sensor rings, the aperture is filled further, corresponding to the sampling theorem, and the synthetic aperture of the measurement data record grows by one ring segment, that is to say by the extent of one sensor ring, measured in the axial direction. As progress continues, a synthetic aperture of virtually any desired size can be formed, containing a sufficient number of measurement data items for three-dimensional, high-resolution image reconstruction. This advantageously makes it possible to also measure faults located well away from the measurement surface with high resolution, since the sound field can be focused synthetically, even at long distances, because of the large synthetic aperture.

A further advantage is the high test speed which can be achieved, while at the same time allowing tomographic 3D reconstruction. Those signals which have been received by the individual ultrasound transducers and have not been rectified, the A images, can preferably be used for reconstruction, forming an information matrix in a mathematical formulation. This information matrix describes the measurement information which is available for tomographic reconstruction. A test head having a total of n ultrasound transducers which both transmit and receive forms, at most, an information matrix having n times n elements, with the elements i,j containing the same information as the elements j,i, on the basis of the reciprocity theorem. If the m ultrasound transducers in a sensor ring are advantageously excited at the same time, and all the ultrasound transducers receive individually, then the matrix is reduced to (n/m)·n elements, which each contain the sum of information items which occurs analogously in the material because of the sound field superposition.

The system can furthermore be reduced to the case in which only one sensor ring transmits in one position of the test head. The matrix then contains only 1·n elements. In this limit case, testing can advantageously be carried out at the highest speed.

The apparatus according to the invention for ultrasound testing of a test body which has a hole which extends in an axial direction contains a test head and a processing unit for carrying out the method according to the invention. In the same way as the hole, the test head extends in an axial direction and has a plurality of sensor rings which are at a distance from one another and are arranged one behind the other in the axial direction. In this case, considered in the axial direction, the ultrasound transducers which are arranged on the senor rings can be arranged both one behind the other and slightly offset with respect to one another. The latter extend on a plane at right angles to the axial direction and have a plurality of ultrasound transducers which are arranged in the circumferential direction of the sensor rings.

The advantages mentioned with respect to the method apply analogously to the apparatus.

According to a first embodiment, the ultrasound transducers in at least one sensor ring are arranged along the entire circumference on the sensor ring. Preferably, the ultrasound transducers are arranged uniformly along the complete circumference on the sensor ring. An apparatus such as this advantageously makes it possible to emit a ring wave.

According to a further embodiment, the transmission elements are separated from one another in the circumferential direction of the sensor ring by a distance which is greater than half the wavelength of a test pulse which can be emitted by the transmission elements—measured in the material of the test body. In other words, considered in the circumferential direction of the sensor ring, the value of the distance between the transmission elements may be greater than that value which results from the sampling theorem. Suitable filter algorithms can be used to compensate for the image disturbances caused in this way, in the evaluation of the measurement data obtained.

According to one development, the transmission elements in sensor rings which follow one another in the axial direction—considered on a projection in the axial direction of the test head—are arranged offset with respect to one another in a common circumferential direction of the test head. The transmission elements in successive sensor rings are preferably each offset with respect to one another through an identical rotation angle in the circumferential direction.

Other features which are considered as characteristic for the invention are set forth in the appended claims.

Although the invention is illustrated and described herein as embodied in a method and a device for ultrasonic testing, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, longitudinal sectional view through a part of a test body and through a test head;

FIG. 2 is a diagrammatic, cross sectional view through the test body and the test head known from FIG. 1;

FIGS. 3A-3f are illustrations of a simulated propagation of a test pulse in the test body at different times;

FIG. 4 is a diagrammatic, perspective view of a 3D reconstruction of a cylindrical section of a test body; and

FIGS. 5-7 are illustrations showing a 2D projection of the 3D reconstruction shown in FIG. 4, onto an xy, yz and xz plane, respectively.

### DETAILED DESCRIPTION OF THE INVENTION

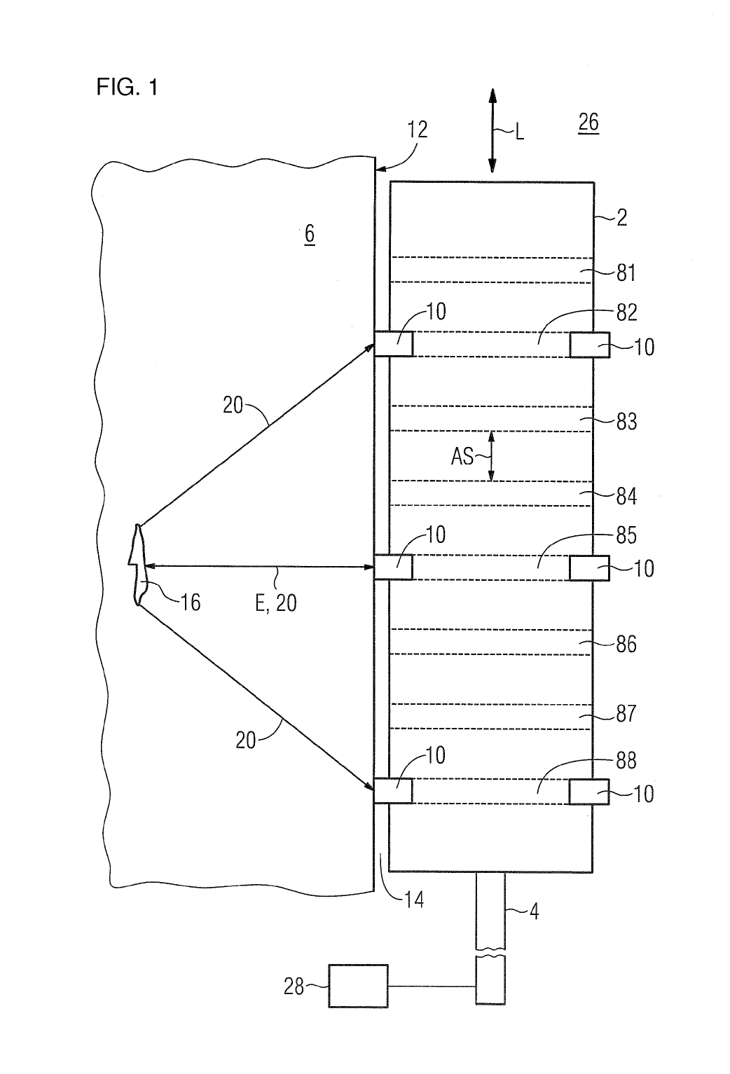

Referring now to the figures of the drawing in detail and first, particularly, to FIG. 1 thereof, there is shown a longitudinal section through a test head 2 located within a hole 26. The test head 2 is inserted into the hole 26 with the aid of a rod 4, which is part of a test lance. Alternatively, the test head 2 may be inserted into the hole 26 with the aid of a pushing/pulling apparatus, using a flexible shaft. By way of example, the test object is assumed to be a hollow shaft 6 which has an axially central hole 26. The test head 2 contains eight sensor rings 81 to 88, which are arranged one behind the other in the axial direction L. In the illustrated example, the axial direction L of the hole coincides with a center longitudinal axis of the test head 2. Each of the sensor rings 81 to 88 contains eight ultrasound transducers 10, which are used both as ultrasound transmitters and as ultrasound receivers. The position of the ultrasound transducers 10 in the circumferential direction of the sensor ring 81 to 88 changes from one sensor ring 81 to 88 to the next. This means that only the ultrasound transducers 10 in the senor rings 82,85 and 88 can be seen in the cross section shown in FIG. 1. The sensor rings 81 to 88, to be more precise their ultrasound transducers 10, are arranged offset with respect to one another such that one sensor ring 81 to 88 merges into the next sensor ring 81 to 88 in the axial direction L by rotation through 15° about the axial direction L. By way of example, the sensor ring 82 merges into the sensor ring 85 after being rotated through 15° three times.

By way of example, those ultrasound transducers 10 which are present in the sensor rings 81 to 88 are pressed in a spring-loaded manner against an inside 12 of the hollow shaft 6. In order to inject an ultrasound field, a suitable coupling medium, such as oil, is additionally located in a gap 14 which exists between the test head 2 and the inside 12 of the hollow shaft 6.

An ultrasound test pulse in the form of a ring wave is injected into the test body, that is to say the hollow shaft 6, in order to test the hollow shaft 6 for a fault 16, which is illustrated by way of example. The injection takes place with the aid of the synchronously operating ultrasound transducers 10 in one of the sensor rings 81 to 88, with the sensor ring 85, for example, being provided to emit the ring wave which is produced by synchronous operation of the ultrasound transducers 10. It is likewise possible to operate the ultrasound transducers 10 sequentially, and to retrospectively superpose the measurement signals obtained, computationally.

In a continuation of the concept of sequential operation of the ultrasound transducers 10 in the sensor ring 81 to 88, and as an alternative to the exemplary embodiment shown in FIG. 1, those sensor rings 81 to 88 are integrated in the test head 2 which are fitted with ultrasound transducers 10 only along a subsection of the circumference of the respective sensor rings 81 to 88. In this case, the ultrasound transducers 10 are combined to form one segment.

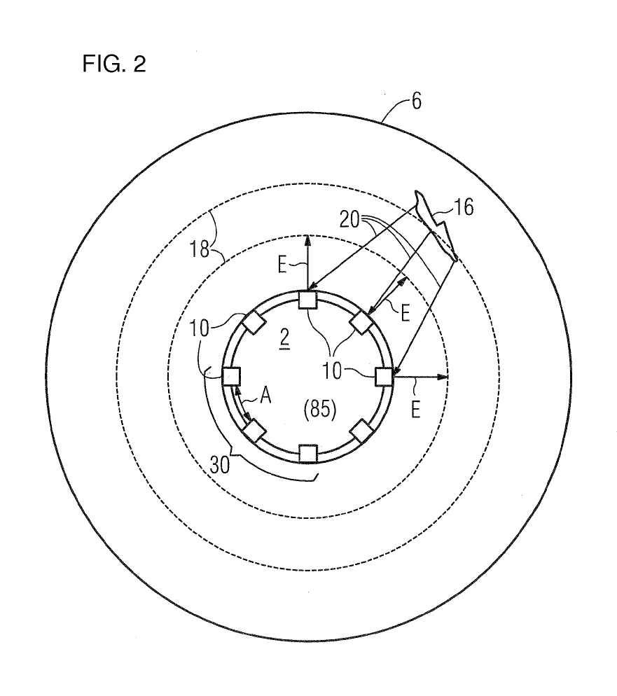

FIG. 2 shows a cross-sectional view of the hollow shaft 6 and of the test head 2 at the level of the sensor ring 85. Eight ultrasound transducers 10, which can be operated synchronously or sequentially, are located along the circumference of the sensor ring 85. Alternatively, the sensor ring 85 in the test head 2 can be configured such that it has three ultrasound transducers 10, only in the segment 30. In this exemplary embodiment, the corresponding segments of the further sensor rings 81 to 84, 86 to 88 have the same number of ultrasound transducers. However, a different number is also possible. The testing of the hollow shaft 6 can be carried out in accordance with the method variants described in the following text with the aid of a test head 2 and according to an exemplary embodiment which is fitted with ultrasound transducers 10 only in the corresponding circumferentially arranged segments of the respective sensor rings 81 to 88.

First of all, the test head 2 as described above is used to scan only a subarea, in the illustrated example approximately one quarter of the hollow shaft 6, along the axial direction L. After this test run, the test head 2 is rotated through, for example, 90° about the axial direction L, and an adjacent quarter segment of the hollow shaft 6 is scanned. After four test runs, the ultrasound test pulses emitted by the segment 30 of the test head 2 at mutually corresponding axial positions are computationally added to form a ring wave. This results in the hollow shaft 6 being scanned completely with the aid of ring waves produced by computational superposition.

Alternatively, once the ultrasound transducers 10 in the segment 30 have been excited to emit an ultrasound test pulse, in order to remain in the example as explained above, the test head 2 can be rotated through 90°, as a result of which a further ultrasound test pulse can be emitted into the adjacent quarter segment of the hollow shaft 6. The test head 2 is not moved in the axial direction L until after the hollow shaft 6 has been scanned with the aid of one complete revolution of the test head 2, allowing computational superposition of the transmitted test pulses to form a ring wave.

For further explanation, reference will now be made once again to FIG. 1, once again assuming a test head 2 which contains sensor rings which are fitted with ultrasound transducers 10 along their complete circumference. In particular, the sensor rings 81 to 88 in the test head 2 are intended to be fitted with ultrasound transducers 10 uniformly along their entire circumference. Furthermore, it is assumed that the ultrasound test pulse is produced in the form of a ring wave by synchronous or sequential operation of the ultrasound transducers 10 in a sensor ring 81 to 88 such as this.

While only one of the sensor rings 81 to 88 is used to emit the ring wave, all the sensor rings 81 to 88, including the transmitting sensor ring 85, are intended to receive the echo signals. FIG. 1 illustrates only the emission direction E of the test pulse originating from the ultrasound transducers 10 in the sensor ring 85. Starting from the ultrasound transducers 10 in the sensor ring 85, the test pulse propagates in the form of a ring wave in the hollow shaft 6, as a test body. In this case, this ring wave is highly divergent in the axial direction L, because the ultrasound transducers 10 have small dimensions in this direction. When the ultrasound test pulse arrives at the fault 16, echo signals 20 are created, and are received by ultrasound transducers 10 which are at a distance from one another. In the illustrated example, these are the ultrasound transducers 10 in the sensor rings 82, 85 and 88. Analogously to the known pulse-echo technique, with the difference that a multiplicity of echo signals 20 are now processed instead of only one echo signal, the orientation and the position of the fault 16 within the hollow shaft 6 can be determined relative to the ultrasound receivers, that is to say the ultrasound transducers 10 in the sensor rings 82, 85 and 88.

The ultrasound transducers 10 in the test head 2 are operated with the aid of a processing unit 28, which is connected via suitable cables to the ultrasound transducers 10. The processing unit 28 controls the injection of the ultrasound field into the hollow shaft 6, and also ensures evaluation of the echo signals 20 received by the ultrasound transducers 10.

FIG. 2 shows a cross-sectional view of the situation described in conjunction with FIG. 1. The figure shows a cross section through the hollow shaft 6 and the test head 2 at the level of the sensor ring 85. By way of example, it is now assumed that the eight ultrasound transducers 10 in the sensor ring 85 are operated synchronously such that they emit a ring wave, which propagates radially in the emission direction E into the hollow shaft 6 as the test body. Two wavefronts 18 of this ring wave are indicated schematically in FIG. 2. The ultrasound test pulse is reflected by the fault 16 which is present in the hollow shaft 6, and the echo signals 20 are detected by the physically separated ultrasound transducers 10 in the sensor ring 85. These echo signals 20 can be used to locate the fault 16 on the section plane illustrated in FIG. 2, that is to say on a plane at right angles to the axial direction L.

Since it is now possible to locate the fault 16 both on a plane parallel to the axial direction L (see FIG. 1) and on a plane at right angles to this axial direction L, the spatial orientation of the fault 16 can be determined uniquely relative to the test head 2.

A further specific exemplary embodiment will be explained in the following text. By way of example, it is for this purpose assumed that the hollow shaft 6 to be tested is composed of steel, and is examined using a test frequency of 4 MHz. The diameter of the internal hole in the hollow shaft 6 is assumed to be 30 mm, likewise by way of example. The aperture of the ultrasound transducers 10 shown in FIGS. 1 and 2 is intended to be two wavelengths, considered in the circumferential direction of the sensor ring 81 to 88. This value is a parameter which can be optimized on the basis of the specific technical test task and governs the number of test channels and the quality of the test image. Since the wavelength of a longitudinal wave at a test frequency of 4 MHz in steel is about 1.5 mm, the aperture of the ultrasound transducers 10 is about 3 mm in the circumferential direction.

The distance A between two ultrasound transducers 10 in the circumferential direction of the sensor rings 81 to 88 is about 9 mm (see FIG. 2). A sensor ring 81 to 88 in each case contains eight ultrasound transducers 10, which are distributed uniformly over the circumference of the respective sensor ring 81 to 88. The magnitude of the distance A in conjunction with an oscillator aperture of two wavelengths infringes the sampling theorem. The artifacts caused in this way may, however, be largely eliminated from the measurement results by the use of suitable filter algorithms.

The ultrasound transducers 10 in successive sensor rings 81 to 88 in the axial direction L have each been moved through 1.5 mm with respect to one another in the circumferential direction; this corresponds (in contrast to the exemplary embodiment shown in FIGS. 1 and 2) to rotation of the relevant sensor ring 81 to 88 through about 5.6°. In other words, the sensor rings 81 to 88 have been moved with respect to one another such that, in the case of an assumed ninth sensor ring, its ultrasound transducers 10 would once again be located at the same position as is in the case of the first sensor ring 81. Since the aperture of the ultrasound transducers is 3 mm and the distance A between the ultrasound transducers is 9 mm, the next oscillator follows after 12 mm. The sensor rings 81 to 88 have therefore each been rotated through 1.5 mm (1.5 mm×8=12 mm) with respect to one another.

The distance AS between the sensor rings 81 to 88 (see FIG. 1) is three and a half wavelengths with an element aperture in the axial direction of half a wavelength, that is to say one sensor ring 81 to 88 is located every six millimeters.

All the sensor rings 81 to 88 are excited to emit a ring wave successively for ultrasound examination of the hollow shaft 6, with the echo signals 20 originating from a fault 16 each being received by all the sensor rings 81 to 88. Once the sensor rings 81 to 88 in the test head 2 have been switched on successively, in which case a process such as this can also be referred to as a test cycle, the test head 2 is moved through half a wavelength in the axial direction L. After eight such test cycles, a complete reception aperture is obtained over the entire length of the test head 2, in which the sensor rings 81 to 88 extend.

If the ultrasound system is operated at a pulse repetition frequency of 1 kHz, and if the test head 2 has already been moved in the axial direction L after a transmission process, then this corresponds to a test speed of 750 mm per second. If all eight sensor rings 81 to 88 are used for transmission, the test speed is slowed down by a factor of eight, and is therefore in the region of 100 mm per second. A hollow shaft 6 with a length of 2 m can be tested in about 20 s at a test speed such as this. Lower test speeds can be used to record stabilizing redundant data records, with the sensor positions overlapping.

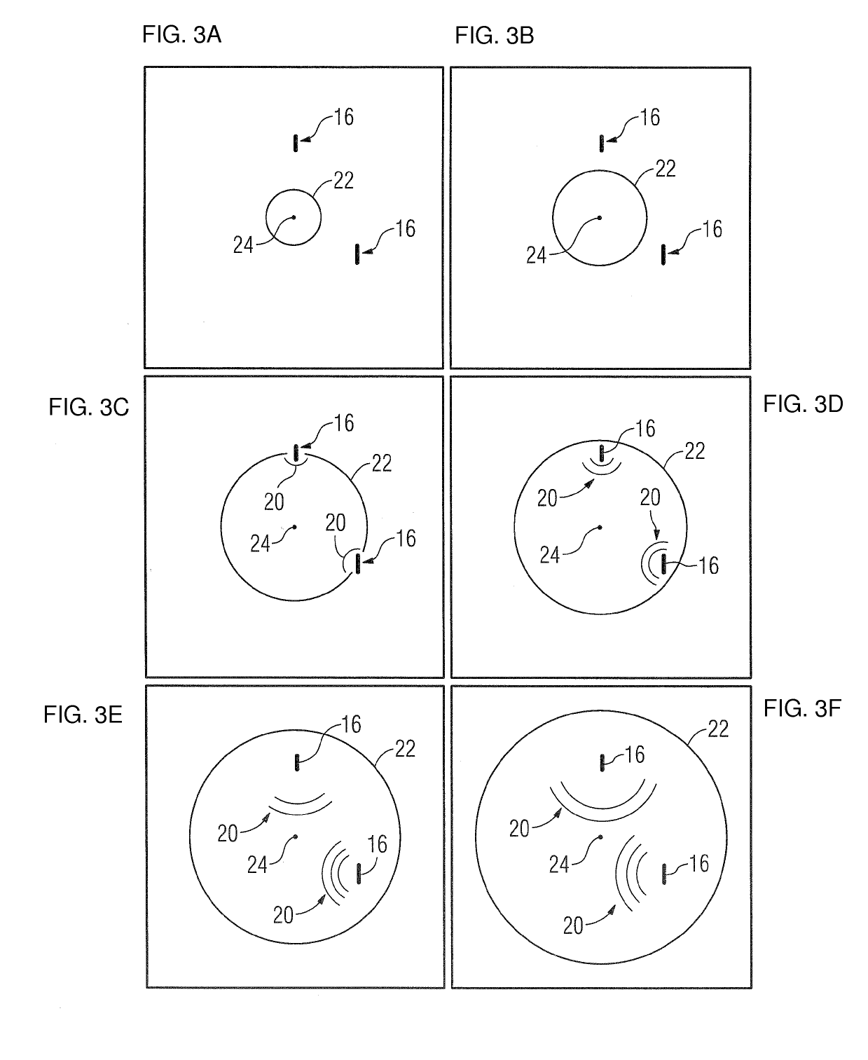

FIGS. 3A-3F show a model calculation on the basis of a conventional elastodynamic code for the propagation of a ring wave in an acoustically isotropic solid body. The ring wave 22 propagates, starting from the sound source 24, into the solid body (see FIGS. 3A and 3B). When this reaches the faults 16, echo signals 20 are formed (see FIG. 3C). The ring wave 22 passes the fault 16, while the scattered echo signals 20 propagate to a greater or lesser extent in the opposite direction in the solid body, depending on the geometry of the faults 16. The ultrasound receivers for reception of the echo signals 20 are also located around the location of the sound source 24 which, for the sake of simplicity, is illustrated here as only being in the form of a point, as a result of which the position of the faults 16 within the solid body can be determined on the basis of the delay time of the echo signals and with the aid of a plurality of receivers at a distance from one another (see FIGS. 3D-3F).

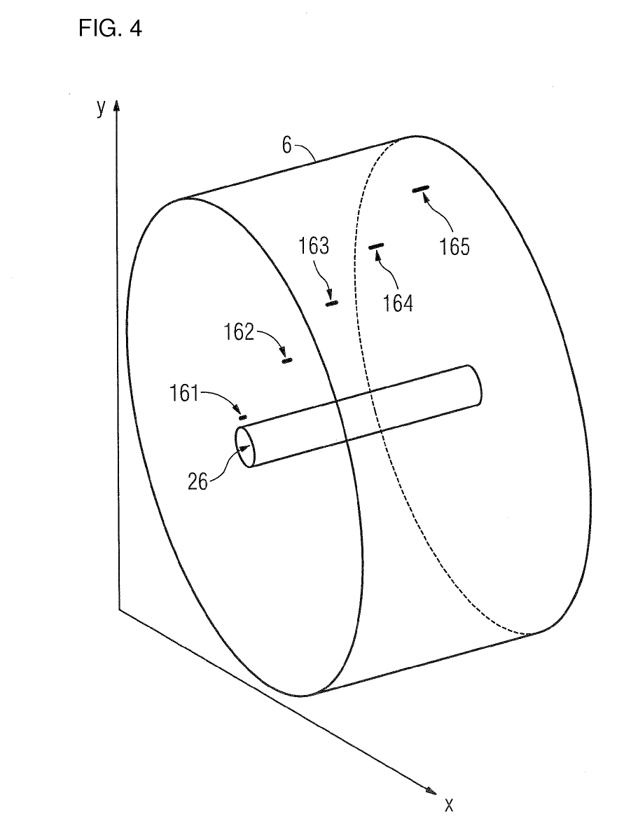

The position and shape of the detected faults 16 are represented in a real 3D image of the test body, using conventional tomographic reconstruction algorithms. The user is therefore presented with a three-dimensional damage image, as is shown by way of example in FIG. 4.

FIG. 4 shows a schematic perspective view of a cylindrical section of a hollow shaft 6 as a test body. In addition to the central hole 26 as a cavity, faults 161 to 165 which are present in the volume can be seen.

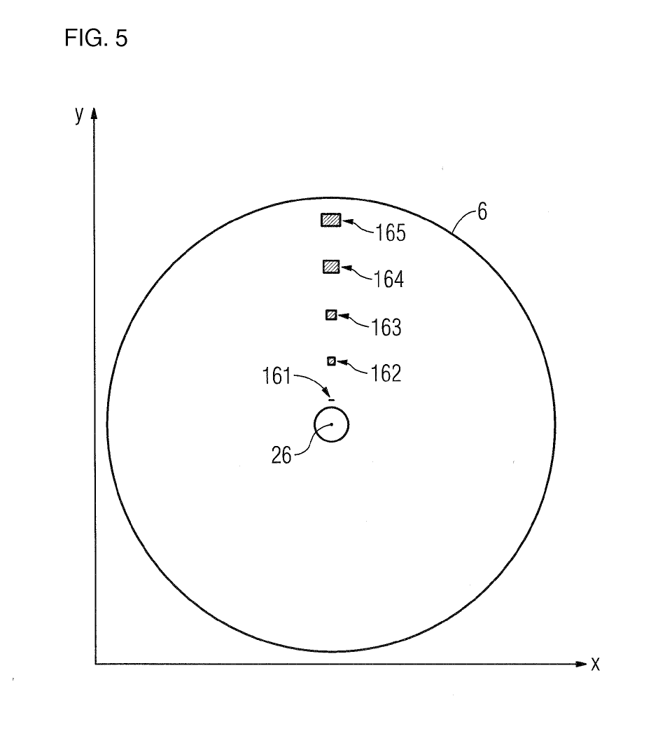

In addition to the 3D view shown in FIG. 4 of the damage image, various projections may be displayed and are shown, by way of example, in FIGS. 5 to 7.

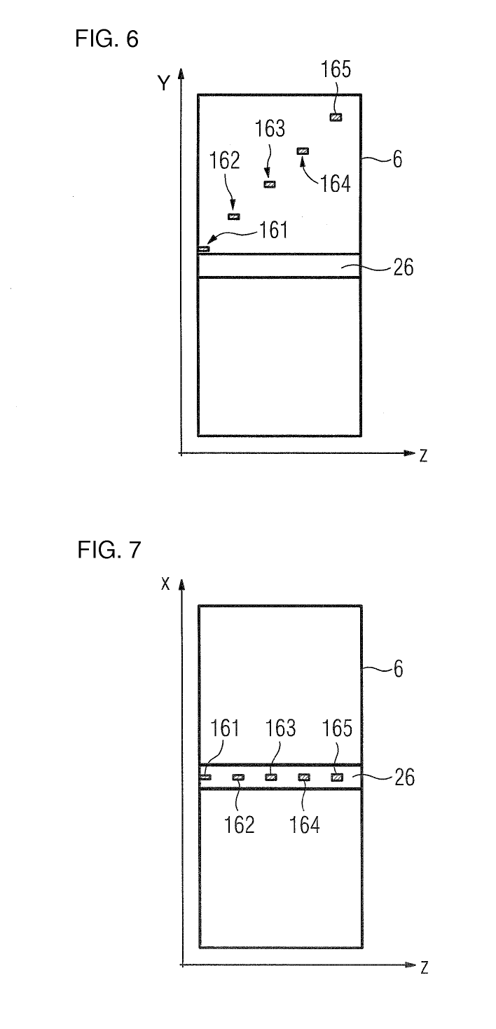

For example, FIG. 5 shows a projection of the three-dimensional reconstruction known from FIG. 4 onto an xy plane. FIGS. 6 and 7 show further projections of this three-dimensional reconstruction onto the yz and xz planes.

1. A method for ultrasound testing of a test body having a hole formed therein and extending in an axial direction, which comprises the following steps of:
disposing a test head within the hole, the test head extending in the axial direction and having a plurality of sensor rings which are at a distance from one another and are disposed one behind the other in the axial direction, the sensor rings extending on a plane at right angles to the axial direction and have a plurality of ultrasound transducers which are at a distance from one another, the ultrasound transducers disposed in a segment of each of said sensor rings extending in a circumferential direction of a respective said sensor ring on at least a subsection of a circumference of the respective sensor ring;
injecting an ultrasound test pulse into the test body, the ultrasound test pulse originating from the ultrasound transducers in the segment of the sensor rings, with the ultrasound transducers being excited synchronously or sequentially to emit individual pulses of a same type, whose superposition results in the ultrasound test pulse;
receiving a first echo signal by a first of the ultrasound transducers and of a second echo signal by a second of the ultrasound transducer in the test head, with the first and second ultrasound transducers being physically at a distance from one another, and with the first and second echo signals being produced by reflection of an injected ultrasound test pulse at one and a same fault present in the test body; and
evaluating measured values of the first and second echo signals to determine at least one of a location or an orientation of the fault in the test body relative to a position of the first and second ultrasound transducers.

2. The method according to claim 1, which further comprises rotating the test head about the axial direction between an injection of two successive ultrasound test pulses.

3. The method according to claim 2, which further comprises:
injecting a multiplicity of test pulses into the test body to scan the test body; and
moving the test head along a test path, which is oriented in the axial direction, between the injection of the two successive ultrasound test pulses.

4. The method according to claim 2, which further comprises at least one of rotating or moving the test head such that a first sound field of a first test pulse and a second sound field of a second test pulse partially overlap one another.

5. The method according to claim 2, which further comprises rotating the test head such that a rotation angle measured on a plane at right angles to the axial direction, between a first position in which a first ultrasound test pulse is emitted and a second position in which a second ultrasound test pulse is emitted, is less than a beam angle, likewise measured on a plane at right angles to the axial direction, of a first sound field of the first ultrasound test pulse.

6. The method according to claim 1, which further comprises disposing the ultrasound transducers in at least one of the sensor rings along a complete circumference on the respective sensor ring, and with the ultrasound transducers in the test head being operated such that the ultrasound test pulse is in a form of a ring wave which propagates at right angles to the axial direction.

7. The method according to claim 6, wherein the ultrasound transducers in an individual one of the sensor rings being operated to emit the ring wave, and with the ultrasound transducers in a plurality of the sensor rings being provided for reception of an echo signal.

8. The method according to claim 6, which further comprises emitting the plurality of ultrasound test pulses for ultrasound testing of the test body, and with the test head being moved along a test path, which is oriented in the axial direction, in a time between an emission of two of the ultrasound test pulses.

9. The method according to claim 8, which further comprises moving the test head along the test path through a step width whose size corresponds to half a wavelength of the ultrasound test pulse used for testing and measured in a material of the test body.

10. The method according to claim 8, which further comprises using the echo signals produced by different ones of the ultrasound test pulses for evaluation of the measured values.

11. The method according to claim 9, which further comprises taking into account the step width in an evaluation of the ultrasound test pulses.

12. The method according to claim 1, which further comprises calculating a 3D tomography of the test body on a basis of echo signals received.

13. An apparatus for ultrasound testing of a test body having a hole formed therein and extending in an axial direction, the apparatus comprising:
a test head having a plurality of sensor rings being at a distance from one another, disposed one behind another in the axial direction, extend on a plane at right angles to the axial direction and contain a plurality of ultrasound transducers disposed at a distance from one another in a circumferential direction of said sensor rings, said ultrasound transducers being disposed in a segment of each of said sensor rings, said segment extending in a circumferential direction of said sensor rings on at least a subsection of a circumference of a respective said sensor ring; and
a processing unit programmed to:
inject an ultrasound test pulse into the test body, the ultrasound test pulse originating from said ultrasound transducers in said segment of said sensor rings, with said ultrasound transducers being excited synchronously or sequentially to emit individual pulses of a same type, whose superposition results in the ultrasound test pulse;
receive a first echo signal by a first of said ultrasound transducers and of a second echo signal by a second of said ultrasound transducer in said test head, with said first and second ultrasound transducers being physically at a distance from one another, and with the first and second echo signals being produced by reflection of the injected ultrasound test pulse at one and a same fault present in the test body; and
evaluate measured values of the first and second echo signals to determine at least one of a location or an orientation of a fault in the test body relative to a position of said first and second ultrasound transducers.

14. The apparatus according to claim 13, wherein said ultrasound transducers in at least one of said sensor rings are disposed along an entire circumference on said one sensor ring.

15. The apparatus according to claim 14, wherein said ultrasound transducers are separated from one another in the circumferential direction of said sensor ring by a distance which is greater than half a wavelength of a test pulse which can be emitted by said ultrasound transducers and measured in a material of the test body.

16. The apparatus according to claim 14, wherein said ultrasound transducers in said sensor rings which follow one another in a longitudinal direction, considered on a projection in the axial direction of said test head, are each moved through a constant rotation angle with respect to one another in a common circumferential direction of said test head.
